(19) United States
(12) Patent Application Publication
(10) Pub. No.: US 2020/0047617 A1
(43) Pub. Date: Feb. 13, 2020

(54) Customizable vehicle dashboard (AKA Instrument Cluster, Instrument Panel, Combination Meter) design

(71) Applicant: Eugene Vlasenko, Bellevue, WA (US)

(72) Inventor: Eugene Vlasenko, Bellevue, WA (US)

(21) Appl. No.: 16/057,620

(22) Filed: Aug. 7, 2018

(51) Int. Cl. B60K 35/00; B60K 37/06

(52) U.S. Cl. CPC B60K 35/00; B60K 37/06; B60K 2350/1008; B60K 2350/1064; B60K 2350/1004

(57) ABSTRACT

Designed system is a software and hardware system to be used as a vehicle dashboard. The system is connected to the vehicle to read the vehicle data. The system has a monitor to render the vehicle data. The system replaces vehicle's instrument cluster installing a monitor facing driver. The system allows user to change appearance of data on it by configuring widgets. User can define a widget data, layout, scripts and custom media using all possible data taken from the vehicle. The media could be user's custom pictures, sound recordings, video, etc. The system makes instrument cluster (aka combination meter) highly customizable. User can make their own appearance and look for the vehicle's data by selecting the vehicle data, widget, layout scripts and media to show it on vehicle instrument cluster platform.

### FIELD OF TECHNOLOGY

This solution is related to vehicle dashboard or vehicle information system. It makes the dashboard more useful and customizable.

### BACKGROUND

Vehicle instrument cluster (aka combination meter) is a component designed to provide vehicle's status to driver. It reports mechanical status, component status, vehicle status data and alerts.

Currently most of the vehicles have manufacturer defined data set layout and style for instrument clusters. Some of them allow limited customization.

### SUMMARY

This disclosure relates to vehicle dashboard (aka Instrument Cluster, Instrument Panel, Combination Meter). New design allows user to define their instrument cluster to their exact needs and taste.

New vehicle dashboard design allows user to design and use their own data set, look and feel of the vehicle instrument cluster. For example, some users may find useful to remove tachometer and extend other widgets like gas level. Some user may want to use numbers for speed instead of arrow or have both. Some of them may want to redesign it completely for their specific needs or taste.

### BRIEF DESCRIPTION OF THE DRAWINGS

FIG. 1 is a schematic component overview

FIG. 2 is a schematic sample of several views in a configuration

### DETAILED DESCRIPTION

User can design and use their own data set, look and feel of the vehicle instrument cluster. For example, some users may find useful to remove tachometer and extend other widgets like gas level. Some user may want to use numbers for speed instead of arrow or have both. Some of them may want to redesign it completely for their specific needs or taste.

The solution is a hardware and software system. The main purpose of the system is to make vehicle cluster panel more useful and customizable. With this system user is able to customize data appearance, appearance behavior to user's needs and taste. The system is able to show more data than standard dashboard.

### Hardware

Hardware for the system is a customized computer.

The hardware maybe made as external and/or internal.
External hardware represents a single block that may be mounted somewhere in the vehicle on driver's sight.
Internal hardware is car generation specific. It made with dimensions match factory cluster assembly. Factory assembly should be replaced by new one. Internal hardware should be able to connect to existent cluster panel connections.

Hardware may have CPU, RAM, storage memory, monitor, GPU and additional controllers for peripheral connections including controllers for protocol connections like CAN BUS, LIN, etc.

### Software Architecture

The software architecture includes several layers

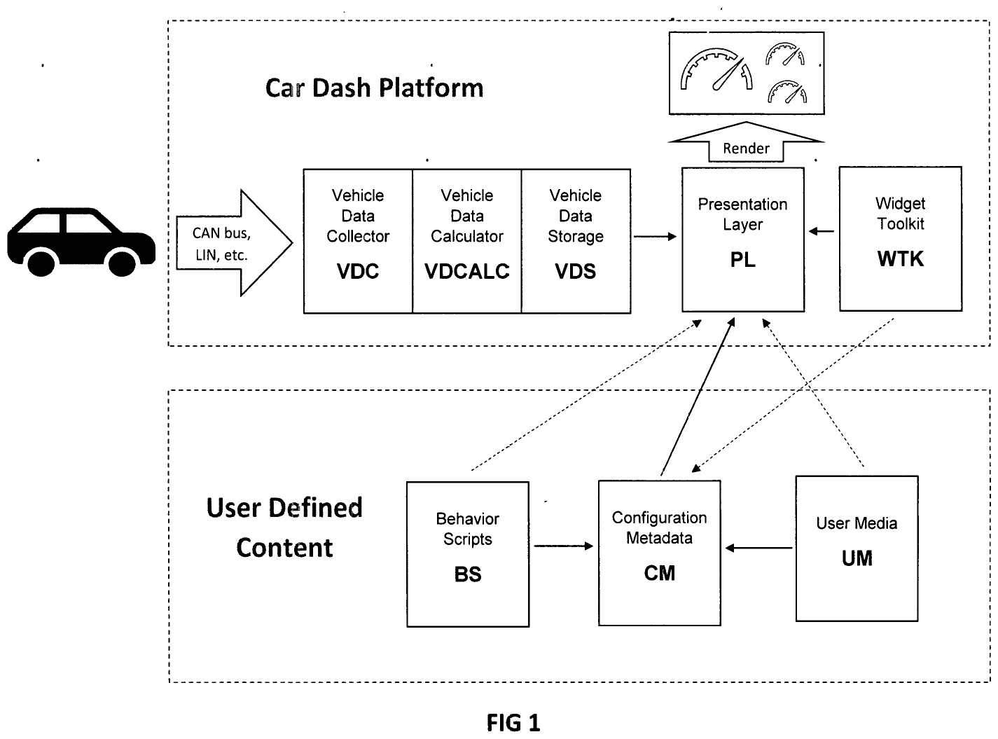

Vehicle Data Collector (VDC) FIG. 1—is a data collector layer specific to data flow interface. It includes CAN bus, LIN bus, sensors wires or any other available data interface. The main purpose of this layer is to abstract Vehicle Data Storage from interfaces and methods used in collecting data.

Vehicle Data Calculator (VDCALC) FIG. 1—is a calculation layer to make ready-to-consume values from the data received by VDC. For example, vehicle system may provide vehicle engine's RPM in some internal units and requires to be converted to rotations per second. In additional, one parameter reading may affect several Vehicle Data Id (VDI), for example vehicle speed affects “Kilometers per hour” and “Miles per hour”.

Vehicle Data Storage (VDS)—is a key-value storage of VDI received from VDCALC. This layer includes Data Expiration Control (DEC). DEC prevents holding last value when data source is not providing new status values.

VDS may be split into two sets of data to store:
1. VDI ID corresponding to VDI Description
2. VDI ID corresponding to VDI Value

Implementation of the VDS could be done by several options:
1. Observable pattern—VDS raises an event with data updates (including events from DEC)
2. Table pattern—VDS becomes a data warehouse available for accessing by data consumers

### Presentation Layer (PL)

PL is the customer facing component it shows customized layout of graphic presentation of VDI from VDS. The representation could be very different depending on data and implemented in widget. It implements graphical representation of one or more values for a corresponding VDI.

PL is shown on a monitor. The monitor may be placed on the place of vehicle's cluster panel by replacing previous one.

PL is only user's facing layer and should be fast enough to show all data defined in current view.

PL may be implemented using other 3D software like OpenGL or DirectX.

PL may use Graphics Processor Unit (if available) to improve performance and appearance.

PL is a composite layer. It includes a set of Views. PL must contain at least one View. Each view may have several Triggers. Triggers define condition of activating view. Only one View may be active at a time.

View without Triggers called Default View. Only one Default View is allowed in system's configuration.

A View represents a layout of widgets.

PL has several components

User's Media (UM) is a set of resources for a widget defined by user. It could be pictures, recorded audio, video, etc.

Behavior Scripts (BS) is a set of scripts to achieve specific behavior of a widget. It may be GLSL or other languages to make custom widget appearance based on VDI value.

Widget Toolkit (WTK) is a set of widgets with different behaviors. Behavior of widget is defined by developer and may be customized through BS. Widget may have default BS and can be changed for specific widget instance. Each widget type may have one or more VDI to take data from VDS or be a widget without any reference to VDS. For example, static picture appearance is not depended on any VDI.

Configuration Metadata (CM) defines widget layout, UM, widget type in WTK and BS.

There are two types of widget—active and decorative. Decorative widget has no connection to VDI and used for decorative purposes like showing a static picture, make border, etc. Active widget is associated to one or more VDI and its appearance is based on the VDI value. Widget behavior is implemented in Widget and may have any form: showing numbers, moving arrows, changing color, etc.

Active widget may be activated (connected to VDS data) and deactivated (disconnected from VDS data). Decorative widget is always deactivated.

Implementation of widget may be done on several options depending on VDS implementation:
1. Observer—Widget holds last known VDI value(s) and presentation until event received from observable VDS
2. Query VDS value every time it is being rendered

### Views

Configuration must contain at least one view defined. View is a set of widget metadata (layout, dimension, user media and scripts) and a set of triggers. Trigger is runtime condition that can be true or false. Sample of trigger is “speed is more then 20 mph”. Trigger may be composite and contain multiple conditions.

System constantly checks all conditions in triggers to define current view.

Configuration that has two views with the same triggers is not valid and should be reconfigured.

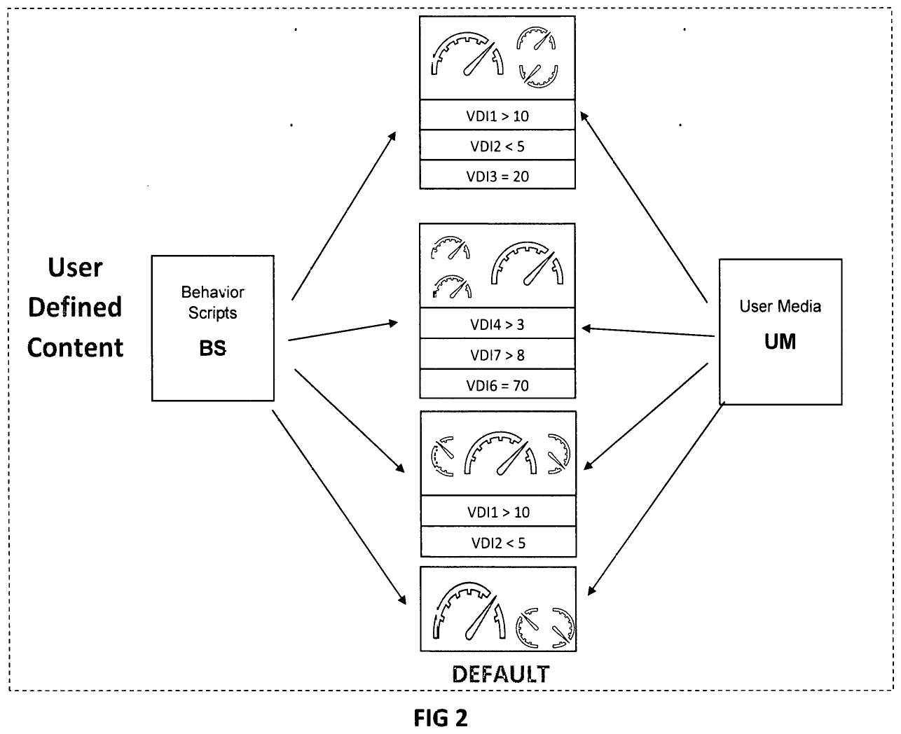

FIG. 2 schematically shows a sample of a configuration with several views with different triggers.

### PL Examples:

In the simplest case PL has one View with no Triggers. In this case the Default View will start initially and will never be changed.
Two views defined: one without triggers, another one for speed more than 50 MpH (freeway mode). First view becomes active as soon as user starts the vehicle. Reaching speed more than 50 MpH makes trigger event to initialize and activate new view associated with the trigger.

### Sensors

The system is hooked up to all vehicle's sensors available through all possible interfaces like on/off signals. CAN BUS. LIN or any other interface implemented in the vehicle for component communication.

In additional to current vehicle's sensors system may have its own sensor set. Sensors like GPS listener, accelerometer sensor, light sensor and other may be implemented to be available to show data, to be part of calculations for other data or affect appearance.

Current Vehicle dashboard supports 2 light modes mostly—daytime and dimmed. Using light sensor makes possible to make dynamic light mode responsive to even small lighting change.

### Widgets

Widgets are atomic building pieces of a view. They are implemented as part of platform

Widget is:
1. Graphical representation of data
2. Decorative element
3. Both 1 and 2

Layout of widgets can be 2 or 3 dimensional. Widget may overlap each other. Front/back positioning is configurable through 3D layout.

The behavior of active widget is related to vehicle data defined in CM. It may be media rotation, show/hide, partial coloring, etc. with vehicle parameter from VDS.

The solution has a set of widgets that makes a widget toolkit.

1. A vehicle informational hardware and software system that is connected to vehicles networks, interfaces and sensors to render vehicle's data by user defined configuration of widget types, layouts, contents and behaviors. The system may have its own sensors to provide their data to widgets or internal use. The system has several views and changes them by corresponding set of triggers.
